(19) United States
(12) Patent Application Publication
(10) Pub. No.: US 2005/0182748 A1
(43) Pub. Date: Aug. 18, 2005

(54) File system control apparatus

(75) Inventors: Tomohiro Hirata, Osaka (JP); Masakazu Urade, Kyoto (JP); Sachiko Maeda, Shiga (JP); Tomoko Uenishi, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/039,878

(22) Filed: Jan. 24, 2005

(30) Foreign Application Priority Data
Feb. 18, 2004 (JP) P2004-041650

(51) Int. Cl. G06F 7/00

(52) U.S. Cl. 707/1

(57) ABSTRACT

A file system control apparatus, which exclusively shares a recording device upon executing first and second file systems, is provided with a file system controller, which controls in such a manner that, even when, during access execution of the first file system to a recording device, an access execution request to the recording device is given from the second file system that is different from the first file system, the access execution of the second file system is not delayed by the access execution of the first file system.

### BACKGROUND OF THE INVENTION

1. Field of the Invention

The present invention relates to a file system control apparatus in which: a plurality of CPUs or applications share a single recording device and in particular, media-based data are always written and read in real time.

2. Description of Related Art

In a conventional file system possessed by an operating system, one file system is assigned to one recording device. Moreover, the recording device is designed on the assumption that data having a small size such as document data and graphics are written therein so that addresses are added, with a size of several kilobytes being set as a basic unit, so as to control data.

In the case when data having a large size, such as media data, are written or read, however, there is a case in which the operating system writes or reads a small amount of data in or from the recording device asynchronously from the media data. The resulting problem is that it is not possible to ensure data transfer of media data with a high bit rate.

Therefore, in order to execute writing and reading operations of media data at high speeds, in a separate manner from the normal file system possessed by the operating system of a computer, a second file system for processing media data is installed in a single recording device, and the second file system is allowed to directly control addresses in the recording device. This makes it possible to ensure continuous transfer of media data, and also to execute high-speed data transfer operations.

As shown in FIG. 14, in a separate manner from a file system (first file system, not shown) inside a host system 4 possessed by an operating system of a computer, a video-signal-use file system 3 (second file system) , which directly controls addresses of media data that are written and read by a recording device 6, is installed. The first file system indirectly manages and controls the media data through the second file system 3. With this arrangement, it becomes possible to execute data transfer at high speeds, while ensuring continuous transfer of the media data.

However, in the case when two file systems simultaneously access the recording device 6, while the file system, which has first accessed, is writing or reading data in the recording device, the file system, which has accessed later, has to wait for the corresponding data writing or reading operation, resulting in a problem.

For example, in a recording-reproduction control device shown in FIG. 14, suppose that, while an HTML file is being read from the recording device 6 and subjected to a browsing process, another media file is read out from the same recording device 6 and subjected to a music reading process. In this case, the reading process of the media file is delayed, with the result that during the music reading process, the reading is interrupted.

### SUMMARY OF THE INVENTION

A file system control apparatus in accordance with the present invention is provided with a first control unit that controls processing of first data, a first file system that is subjected to the processing by the first control unit, a second control unit that controls processing of second data, a second file system that is subjected to the processing by the second control unit, and a file system controller that controls the first and second file systems, and in this arrangement, even when, upon execution of an access to the recording device by the first file system, an access execution request for the recording device is given by the second file system, the file system controller carries out a control operation so as not to delay the access execution of the second file system due to the access execution of the first file system.

The first data are, for example, general data (non-media data) such as a document data, and the second data are, for example, media data such as AV data. The processing of the first data is, for example, a writing or reading process of general data, and the processing of the second data is, for example, a writing or reading process of media data.

In accordance with the file system control apparatus of the present invention, for example, even in the case when a writing or reading process of non-media data and a writing or reading process of media data are simultaneously requested, the writing or reading process of media data is always executed in real time by carrying out arbitration between the first and second file systems.

In one preferable mode, when, upon execution of an access to the recording device by the first file system, an access execution request for the recording device is given by the second file system, the file system controller suspends the access execution of the first file system to the recording device so that the access execution of the second file system to the recording device is preferentially carried out. In accordance with this mode, it becomes possible to ensure real-time processing of writing or reading of media data.

In another preferable mode, upon completion of an access execution of the second file system to the recording device, the file system controller resumes the access execution of the first file system to the recording device again. In accordance with this mode, the writing or reading operation of non-media data, which has been suspended by the writing or reading operation of media data, is executed without causing adverse effects to the media data processing.

In still another preferable mode, the first and second file systems have respective priorities, and the second file system has a higher priority than the first file system. In accordance with this mode, since the priority of media data is maintained higher so that the same effects as described above can be obtained.

In still another preferable mode, the first and second file systems are respectively executed on the corresponding CPUs.

In still another preferable mode, the first and second file systems are controlled in their executions respectively by the corresponding applications.

In still another preferable mode, the second file system is provided with a cache buffer, and while the first file system is not executing an access to the recording device, the file system controller carries out controlling processes so that the corresponding data of the recording device is preliminarily transferred to the cache buffer; thus, the access execution of the second file system to the cache buffer and the access execution of the first file system to the recording device are carried out simultaneously. In accordance with this mode, with respect to media processing data having a higher priority, by preliminarily transferring these data to the cache buffer, it becomes possible to execute the corresponding processing independent of the non-media processing data.

In still another preferable mode, the second file system is further provided with a buffer-size managing unit, and upon notification of the fact that the cache buffer has been completely filled from the buffer-size managing unit, the file system controller allows the first file system to execute an access to the above-mentioned recording device, while upon notification of the fact that the cache buffer has become empty from the buffer-size managing unit, it controls so that the corresponding data of the recording device is preliminarily transferred to the cache buffer, when the first file system is not executing an access to the recording device. In accordance with this mode, it becomes possible to properly carry out access controlling processes of file systems, in response to the size of the cache buffer.

In still another preferable mode, either the first or second file system is provided with a secure mechanism, and the file system controller carries out controlling operations so that the access execution of the second file system to the recording device is preferentially carried out depending on the presence or absence of the secure mechanism.

In still another preferable mode, either the first or second file system is provided with a journaling mechanism, and the file system controller carries out controlling operations so that the access execution of the second file system to the recording device is preferentially carried out depending on the presence or absence of the journaling mechanism.

In still another preferable mode, the file system controller, which is provided with a recording-reproduction time managing unit that outputs a constant cycle, controls operations so that an access execution of the second file system to the recording device is carried out every constant cycle. In accordance with this mode, media processing, which has a higher frequency of process executions can be effectively carried out every constant cycle.

In still another preferable mode, time during which an access execution of the first file system to the recording device is carried out is made different from time during which an access execution of the second file system to the recording device is carried out. In accordance with this mode, it becomes possible to execute precise processes finely determined in accordance with characteristics of media processing.

In still another preferable mode, the file system controller is provided with a data-type managing unit that reads data-type information possessed by the first and second file systems, and in accordance with the data-type information, the second file system may be allowed to preferentially execute an access to the recording device. In accordance with this mode, by giving only the data type of media processing, it becomes possible to preferentially execute the corresponding process.

In this mode, it is preferable to allow the second file system to indicate the data type of media processing, and also to allow the first file system to indicate the data type of the other general data processing.

### BRIEF DESCRIPTION OF THE DRAWINGS

The present invention is illustrated by way of example and not limitation in the figures of the accompanying drawings, in which like references indicate similar elements and in which:

FIG. 1 is a block diagram that shows a structure of a file system control apparatus in accordance with an embodiment 1 of the present invention;

FIG. 2 is a block diagram that shows a structure of a file system control apparatus in accordance with an embodiment 2 of the present invention;

FIG. 3 is a block diagram that shows a structure of a file system control apparatus in accordance with an embodiment 3 of the present invention;

FIG. 4 is a block diagram that shows a structure of a file system control apparatus in accordance with an embodiment 4 of the present invention;

FIG. 5 is a block diagram that shows a structure of a file system control apparatus in accordance with an embodiment 5 of the present invention;

FIG. 6 is a block diagram that shows a structure of a file system control apparatus in accordance with an embodiment 6 of the present invention;

FIG. 7 is a block diagram that shows a structure of a file system control apparatus in accordance with an embodiment 7 of the present invention;

FIG. 8 is a block diagram that shows a structure of a file system control apparatus in accordance with an embodiment 9 of the present invention;

FIG. 9A is a drawing that shows accessing operations to a recording device from each of CPUs;

FIG. 9B is a drawing that shows actual data transferring processes in a conventional system;

FIG. 9C is a drawing that shows actual data transferring processes in the embodiments 1, 2, 5, 6 and 9;

FIG. 10A is a drawing that shows accessing operations to a recording device from each of CPUs;

FIG. 10B is a drawing that shows actual data transferring processes in a conventional system;

FIG. 10C is a drawing that shows actual data transferring processes in the embodiments 3 of the present invention;

FIG. 11A is a drawing that shows accessing operations to a recording device from each of CPUs;

FIG. 11B is a drawing that shows actual data transferring processes in a conventional system;

FIG. 11C is a drawing that shows actual data transferring processes in the embodiments 4 of the present invention;

FIG. 12A is a drawing that shows accessing operations to a recording device from each of CPUs;

FIG. 12B is a drawing that shows actual data transferring processes in a conventional system;

FIG. 12C is a drawing that shows actual data transferring processes in the embodiment 7 of the present invention;

FIG. 13A is a drawing that shows accessing operations to a recording device from each of CPUs;

FIG. 13B is a drawing that shows actual data transferring processes in a conventional system;

FIG. 13C is a drawing that shows actual data transferring processes in the embodiments 8 of the present invention; and

FIG. 14 is a block diagram that shows a structure of a conventional file system control apparatus.

### DETAILED DESCRIPTION OF PREFERRED EMBODIMENTS OF THE INVENTION

Referring to attached drawings, the following description will discuss file system control apparatuses in accordance with preferred embodiments of the present invention in detail.

### Embodiment 1

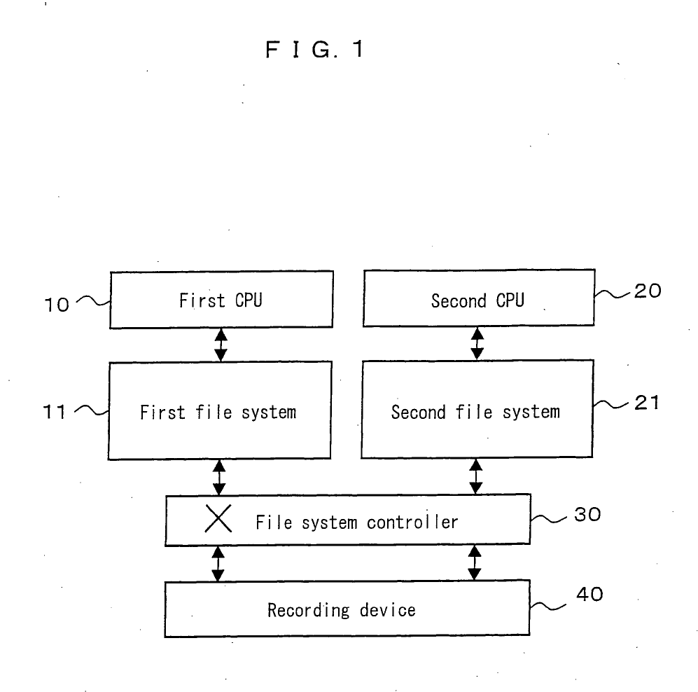

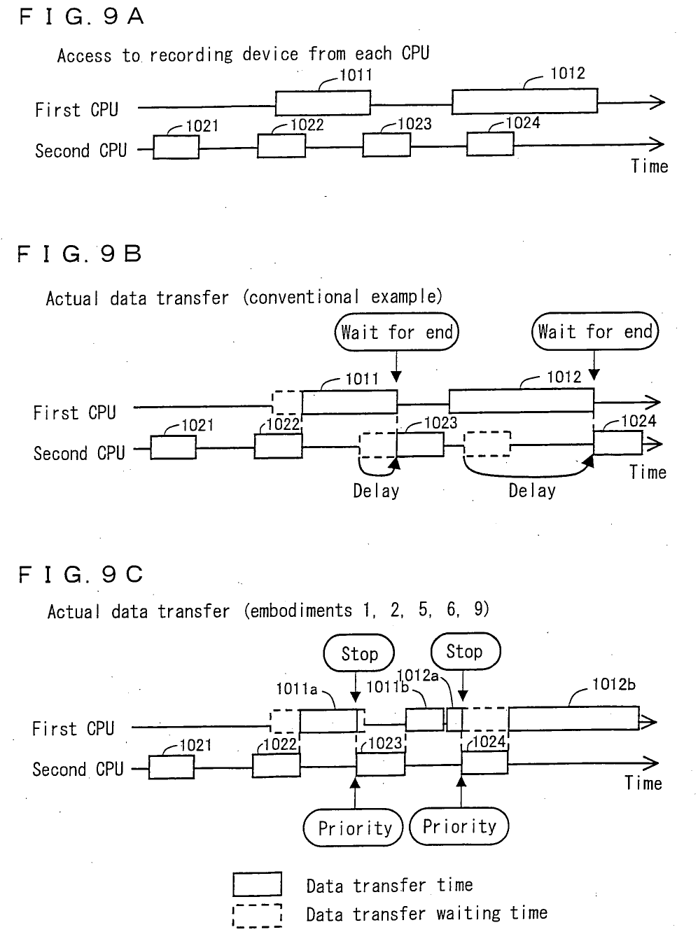

Referring to FIGS. 1 and 9, a file system control apparatus in accordance with the embodiment 1 of the present invention is explained.

In FIG. 1, a first CPU 10 mainly controls writing and reading operations of general data such as document data. Processes for the first file system 11 are executed by a first CPU 10. A second CPU 20 mainly executes writing and reading operations of media data such as AV (audio-visual) data. Processes for the second file system 21 are executed by the second CPU 20.

A file system controller 30, which carries out arbitration between a first file system 11 as well as a second file system 21 and a recording device 40. Specifically, the controller 30 judges whether an access execution request for the recording device 40 is given by the second CPU 20 upon execution of an access to the recording device 40 by the first CPU 10, and carries out controlling operation so as to stop the access of the first file system 11, in the case when the second CPU 20 gives the access while the first CPU 10 is executing the access, so as to allow the second file system 21 to preferentially make an access.

The recording device 40 is a recording device that is commonly used by the first file system 11 and the second file system 21.

In FIG. 9, reference numerals 1011 and 1012 represent data writing and reading operations executed by the first CPU 10, and 1021, 1022, 1023 and 1024 represent data writing and reading operations executed by the second CPU 20.

In the above-mentioned file system control apparatus, the first CPU 10 carries out writing and reading operations of general data such as document data on the single recording device 40 through the first file system 11, and the second CPU 20 carries out writing and reading operations of media data such as AV data thereon through the second file system 21.

In the case when, while the first CPU 10 is making an access to the recording device 40, the second CPU 20 also makes an access thereto, the file system controller 30 stops the data accessing operation of the first file system 11, and allows the second file system 21 to preferentially make an access.

For example, as shown in FIG. 9, in data writing and reading operations in the conventional system, in the case when, while the first CPU 10 is executing a data writing or reading operation 1011, the second CPU 20 executes a writing or reading operation 1023 of data in parallel therewith, the second CPU 20 has to wait before executing the data writing or reading operation 1023 until the first CPU 10 has completed the data writing or reading operation 1011, resulting in a delay.

However, in the first embodiment 1, the data writing or reading operation 1011 of the first CPU 10 is stopped, and the data writing or reading operation 1023 of the second CPU 20 is preferentially executed. As a result, the CPU 20, which executes the writing or reading operation on media data, is allowed to always execute the data writing or reading operation on demand.

In other words, with the above-mentioned arrangement, the writing or reading operation of media data is executed without being adversely influenced by the writing or reading operation of general data. In other words, it becomes possible to always carry out a writing or reading operation of media data in real time.

### Embodiment 2

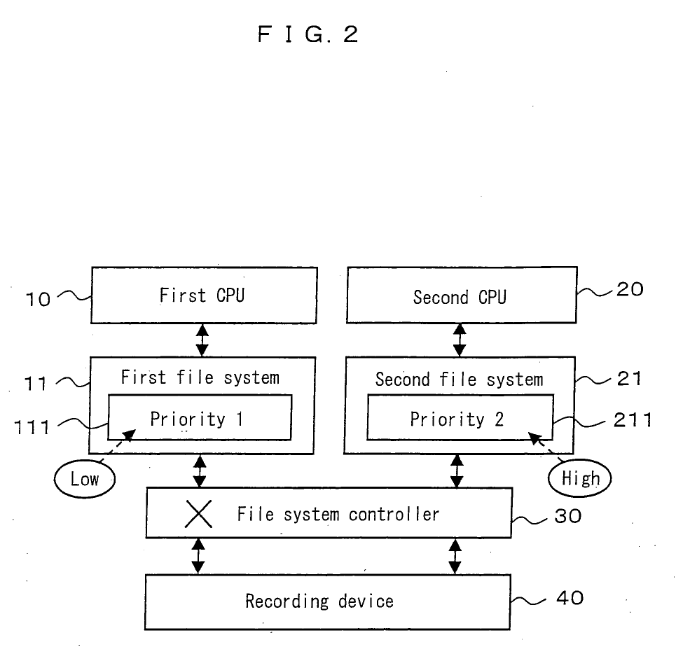

Referring to FIGS. 2 and 9, a file system control apparatus in accordance with the embodiment 2 of the present invention is explained.

In FIG. 2, reference numeral 111 represents a priority given to the first file system 11, and reference numeral 211 represents a priority given to the second file system 21. Since the other structures are the same as those of the embodiment 1, the same parts are indicated by the same reference numerals, and the description thereof is omitted.

In a file system control apparatus of the present embodiment, the first CPU 10 executes a writing or reading operation of general data such as document data on the single recording device 40 through the first file system 11, and the second CPU 20 executes a writing or reading operation of media data such as the AV data thereon through the second file system 21.

Here, the two first file systems 11 and 12 are allowed to respectively have priorities 111 and 211 so that the priority 211 of the second file system 21 that executes a writing or reading operation on media data is set higher than the priority 111 of the first file system 11 that executes a writing or reading operation on general data. Thus, in the case when, while the first CPU 10 is making an access to the recording device 40, the second CPU 20 also makes an access thereto, the file system controller 30 stops the data accessing operation of the first file system 11 having the lower priority, and allows the second file system 21 having the higher priority to preferentially make an access.

For example, as shown in FIG. 9, in data writing and reading operations in the conventional system, in the case when, while the first CPU 10 is executing a data writing or reading operation 1011, the second CPU 20 executes a writing or reading operation 1023 of data in parallel therewith, the second CPU 20 has to wait before executing the data writing or reading operation 1023 until the first CPU 10 has completed the data writing or reading operation 1011, resulting in a delay.

However, in the second embodiment 2, the data writing or reading operation 1011 of the first CPU 10 that makes an access through the first file system 11 having the lower priority is stopped, and the data writing or reading operation 1023 of the second CPU 20 that makes an access through the second file system 21 having the higher priority is preferentially executed. As a result, the CPU 20, which executes the writing or reading operation on media data, is allowed to always execute the data writing or reading operation on demand.

In other words, with the above-mentioned arrangement, the writing or reading operation of media data is executed without being adversely influenced by the writing or reading operation of general data. Consequently, it becomes possible to always carry out a writing or reading operation of media data in real time.

### Embodiment 3

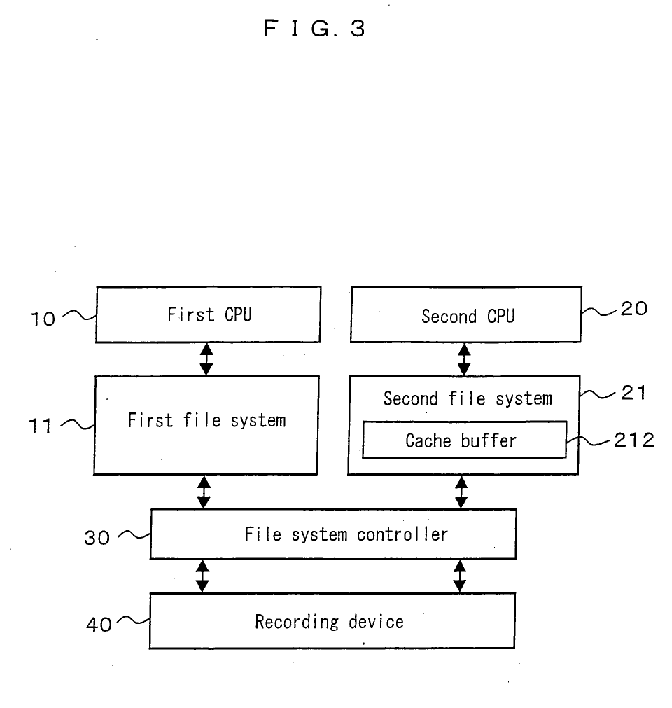

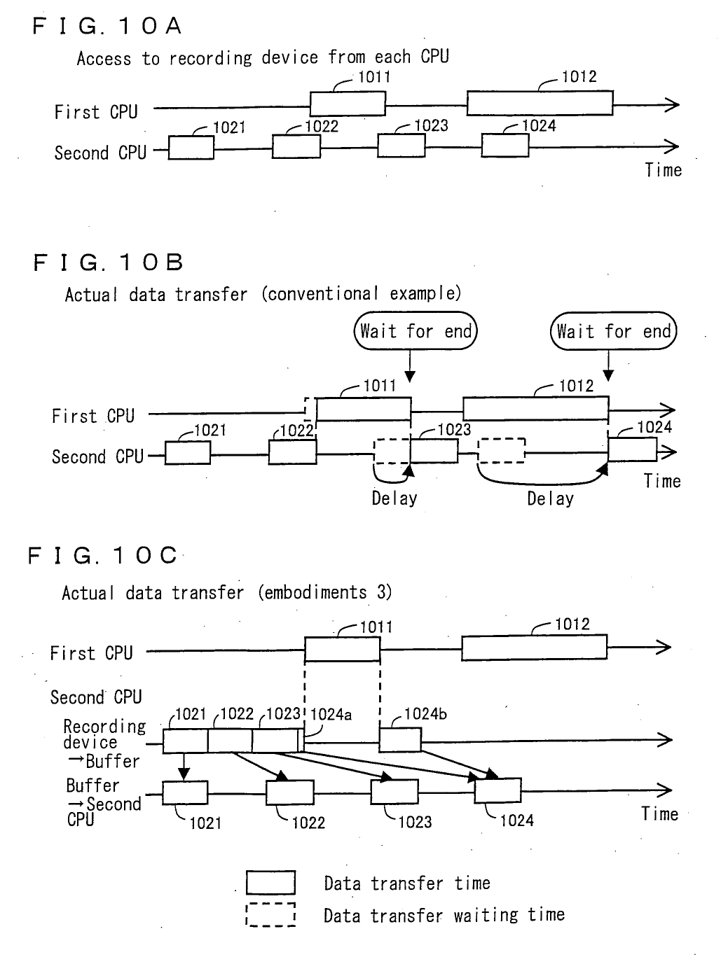

Referring to FIGS. 3 and 10, a file system control apparatus in accordance with the embodiment 3 of the present invention is explained.

In FIG. 3, reference numeral 212 represents a cache buffer installed in the second file system 21. Since the other structures are the same as those of the embodiment 1, the same parts are indicated by the same reference numerals, and the description thereof is omitted.

In a file system control apparatus of the present embodiment, the first CPU 10 executes a writing or reading operation of general data such as document data on the single recording device 40 through the first file system 11, and the second CPU 20 executes a writing or reading operation of media data such as AV data thereon through the second file system 21.

Here, it is featured that with respect to the media data, the CPU carries out a writing or reading operation on a piece of data cyclically in accordance with the sampling rate and the like of the media data. For this reason, it is possible to preliminarily obtain necessary data information (file name, a writing and reading cycle and the like).

Therefore, by installing the cache buffer 212 in the second file system 21, the file system controller 30 is allowed to preliminarily store media data required by the second CPU 20 in the cache buffer 212, while the first CPU 10 is not executing a data writing or reading operation.

For example, as shown in FIG. 10, in the present embodiment, before the first CPU 10 executes the data writing or reading operation 1011 on the recording device 40, the writing or reading operations 1021, 1022, 1023 and 1024a of required data are preliminarily carried out so that the resulting written or read data are stored in the cache buffer 212. The second CPU 20 executes writing or reading operations of 1021, 1022, 1023, 1024a stored in the cache buffer 212. Thus, even while the first CPU 10 is executing the data writing or reading operation 1011 on the recording device 40, the second CPU 20 is allowed to execute the writing or reading operations 1022 and 1023 of required data simultaneously. Since the device to be accessed by the second CPU 20 is not the recording device 40, but the cache buffer 212, the access of the first CPU 10 to the recording device 40 is permitted. Thus, the first CPU 10 and the second CPU 20 are allowed to carry out writing or reading operations simultaneously.

In other words, the above-mentioned arrangement makes it possible to execute a writing or reading operation of media data, without being influenced by a writing or reading operation of general data. In other words, it becomes possible to always carry out a writing or reading operation of media data in real time.

### Embodiment 4

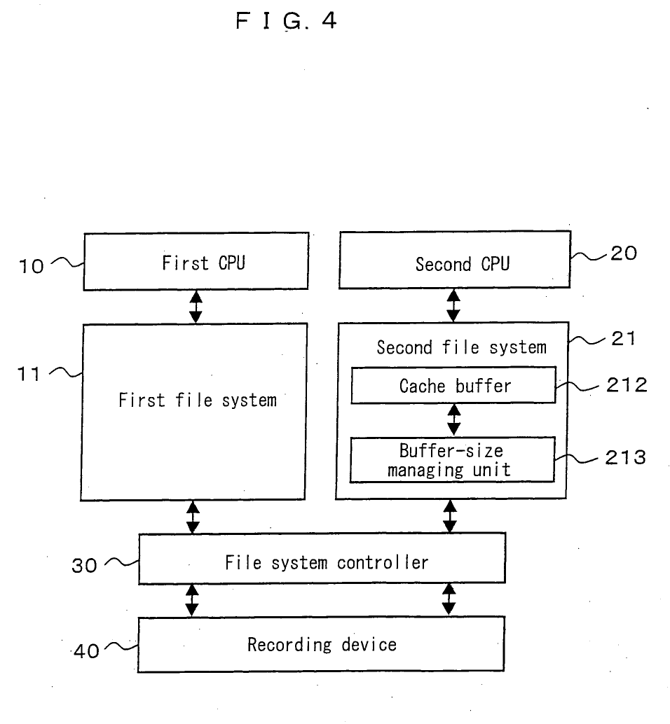

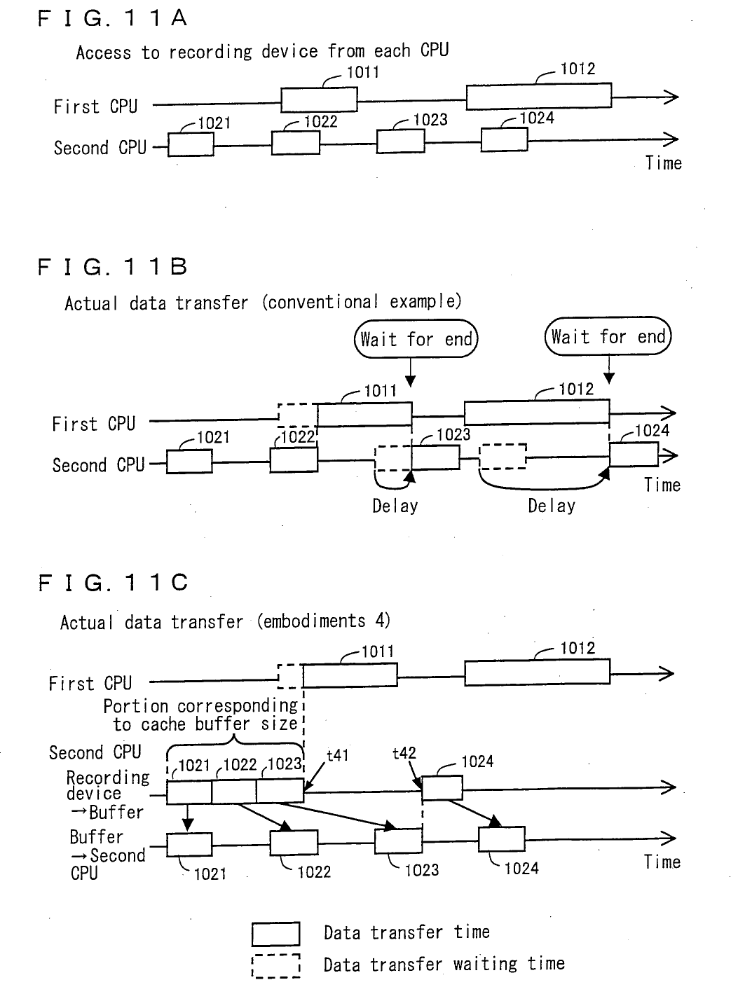

Referring to FIGS. 4 and 11, a file system control apparatus in accordance with the embodiment 4 of the present invention is explained.

In FIG. 4, reference numeral 213 represents a buffer-size managing unit that controls the writing size of the cache buffer 212 that is the same as that shown in FIG. 3, and informs the file system controller 30 of the results. Since the other structures are the same as those of the embodiment 3 shown in FIG. 3, the same parts are indicated by the same reference numerals, and the description thereof is omitted.

In a file system control apparatus of the present embodiment, in the same manner as the embodiment 3, the first CPU 10 executes a writing or reading operation of general data such as document data on the single recording device 40 through the first file system 11, and the second CPU 20 executes a writing or reading operation of media data such as AV data thereon through the second file system 21 that has the cache buffer 212.

While the first CPU 10 is not executing a data writing or reading operation, the second CPU 20 preliminarily stores required media data in the cache buffer 212. The buffer-size managing unit 213 controls the writing size of the cache buffer 212, and when the cache buffer 212 has been completely filled, it informs the file system controller 30 of this fact.

Upon receipt of the information from the buffer-size managing unit 213, the file system controller 30 shifts processes so that the first CPU 10 can execute a data writing or reading operation.

Moreover, when the cache buffer 212 has become empty, the buffer-size managing unit 213 informs the file system controller 30 of this fact, and the cache buffer 212 starts storing media data.

For example, as shown in FIG. 11, in the present embodiment, before the first CPU 10 executes a data writing or reading operation on the recording device 40, the file system controller 30 preliminarily carries out the writing or reading operations 1021, 1022 and 1023 of necessary data so that the resulting written or read data are stored in the cache buffer 212.

At time point t41 when the cache buffer 212 has been completely filled, the process is shifted to the data writing or reading operation 1011 of the first CPU 10. Moreover, at time point t42 when the cache buffer 212 has become empty, the data writing or reading operation 1024 is again executed on the cache buffer 212.

Thus, even while the first CPU 10 is executing the data writing or reading operation 1011 on the recording device 40, the second CPU 20 is allowed to execute writing or reading operations 1022 and 1023 of required data simultaneously. Since the device to be accessed by the second CPU 20 is not the recording device 40, but the cache buffer 212, the access of the first CPU 10 to the recording device 40 is permitted. Thus, the first CPU 10 and the second CPU 20 are allowed to carry out writing or reading operations simultaneously.

In other words, the above-mentioned arrangement makes it possible to execute a writing or reading operation of media data, without being influenced by a writing or reading operation of general data. In other words, it becomes possible to always carry out a writing or reading operation of media data in real time.

### Embodiment 5

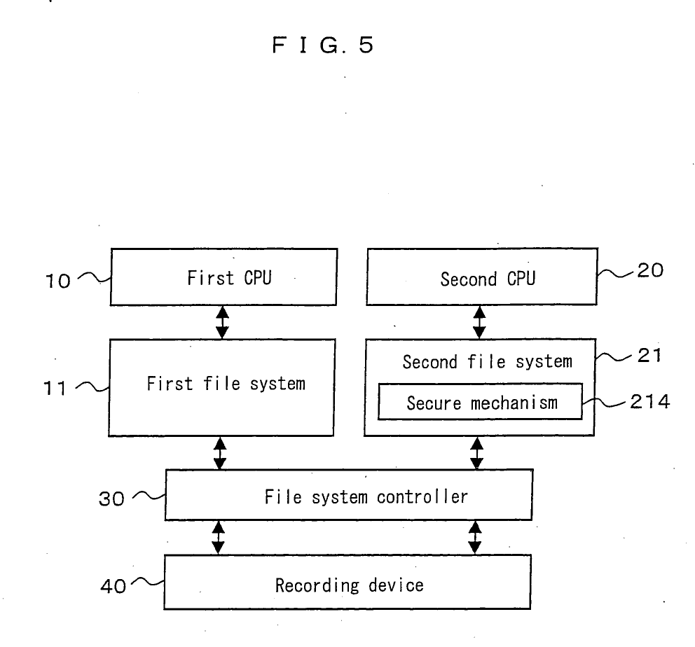

Referring to FIGS. 5 and 9, a file system control apparatus in accordance with the embodiment 5 of the present invention is explained.

In FIG. 5, reference numeral 214 represents a secure mechanism that relates to copyright protection and secrets protection. Since the other structures are the same as those of the embodiment 1 shown in FIG. 1, the same parts are indicated by the same reference numerals, and the description thereof is omitted.

In a file system control apparatus of the present embodiment, the first CPU 10 executes a writing or reading operation of general data such as document data on the single recording device 40 through the first file system 11, and the second CPU 20 executes a writing or reading operation of media data such as the AV data thereon through the second file system 21 that has the secure mechanism 214.

The file system controller 30 distinguishes the first file system 11 having no the secure mechanism and the second file system 21 having the secure mechanism 214 so that, when the first CPU 10 and the second CPU 20 make accesses simultaneously, the process of the second CPU 20 that makes an access through the second file system 21 having the secure mechanism 214 is preferentially carried out.

For example, as shown in FIG. 9, the data writing or reading operation 1011 of the first CPU 10 is stopped, and the data writing or reading operation 1023 of the second CPU 20 is preferentially carried out. As a result, the second CPU 20, which executes a writing or reading operation of media data, is allowed to always execute a data reading or writing operation on demand.

In other words, the above-mentioned arrangement makes it possible to execute a writing or reading operation of media data, without being influenced by a writing or reading operation of general data. In other words, it becomes possible to always carry out a writing or reading operation of media data in real time.

### Embodiment 6

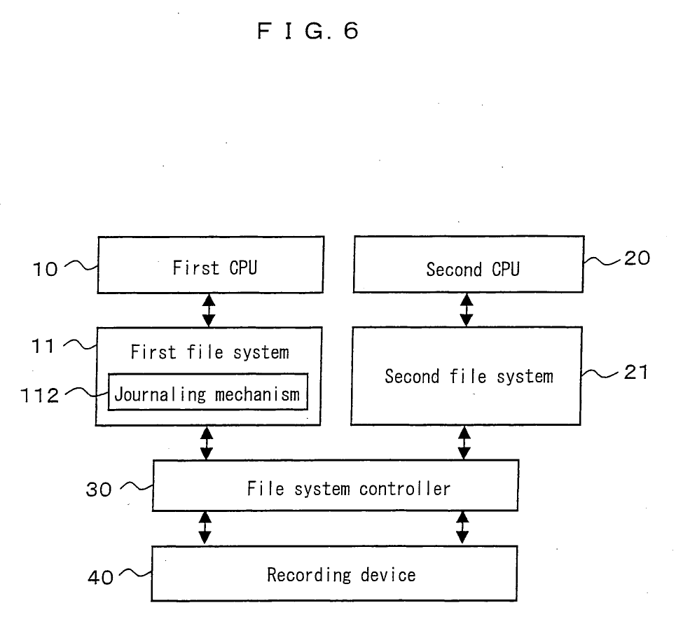

Referring to FIGS. 6 and 9, a file system control apparatus in accordance with the embodiment 6 of the present invention is explained.

In FIG. 6, reference numeral 112 represents a journaling mechanism that carries out various kinds of history managements. Since the other structures are the same as those of the embodiment 1 shown in FIG. 1, the same parts are indicated by the same reference numerals, and the description thereof is omitted.

In a file system control apparatus of the present embodiment, the first CPU 10 executes a writing or reading operation of general data such as document data on the single recording device 40 through the first file system 11 that has the journaling mechanism 112, and the second CPU 20 executes a writing or reading operation of media data such as AV data thereon through the second file system 21.

The file system controller 30 distinguishes the first file system 11 that has the journaling mechanism 112 and the second file system 21 that has no journaling mechanism so that, when the first CPU 10 and the second CPU 20 make accesses simultaneously, the process of the second CPU 20 that makes an access through the second file system 21 that has no journaling mechanism is preferentially carried out.

For example, as shown in FIG. 9, the data writing or reading operation 1011 of the first CPU 10 is stopped, and the data writing or reading operation 1023 of the second CPU 20 is preferentially carried out. As a result, the second CPU 20, which executes a writing or reading operation of media data, is allowed to always execute a data reading or writing operation on demand.

In other words, the above-mentioned arrangement makes it possible to execute a writing or reading operation of media data, without being influenced by a writing or reading operation of general data. In other words, it becomes possible to always carry out a writing or reading operation of media data in real time.

### Embodiment 7

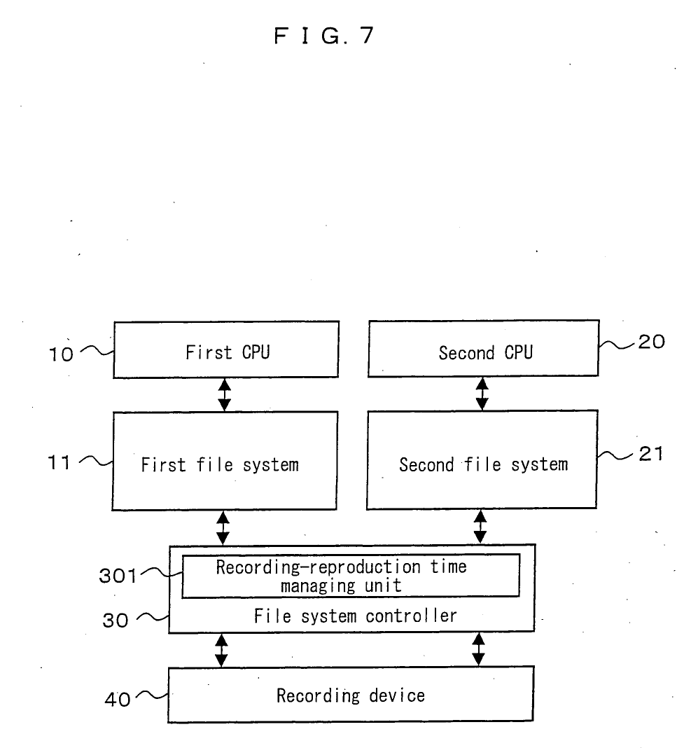

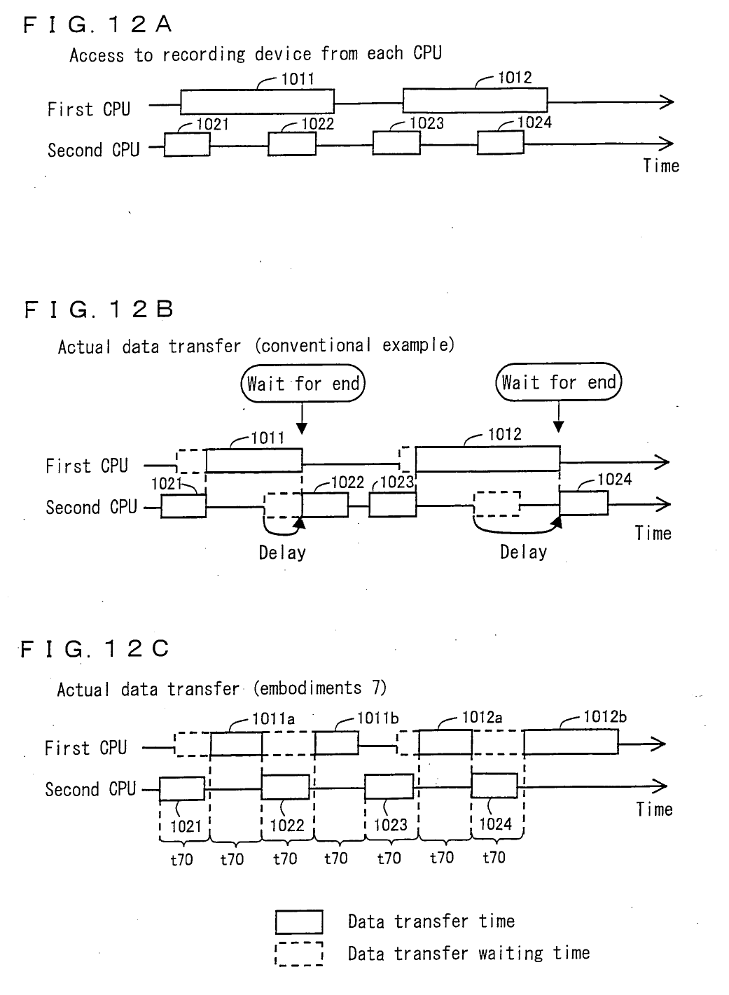

Referring to FIGS. 7 and 12, a file system control apparatus in accordance with the embodiment 7 of the present invention is explained.

In FIG. 7, reference numeral 301 represents a recording-reproduction time managing unit that carries out controlling processes so that the writing or reading operation of the first CPU 10 and the writing or reading operation of the second CPU 20 are executed in a manner so as to be cyclically exchanged. In the case when the first CPU 10 and the second CPU 20 make accesses simultaneously, the writing or reading operation of the first CPU 10 and the writing or reading operation of the second CPU 20 are executed in a manner so as to be cyclically exchanged. These operations are controlled by the recording-reproduction time managing unit 301 inside the file system controller 30. Since the other structures are the same as those of the embodiment 1 shown in FIG. 1, the same parts are indicated by the same reference numerals, and the description thereof is omitted.

In a file system control apparatus of the present embodiment, the first CPU 10 executes a writing or reading operation of general data such as document data on the single recording device 40 through the first file system 11, and the second CPU 20 executes a writing or reading operation of media data such as the AV data thereon through the second file system 21.

For example, the first CPU 10 and the second CPU 20 execute data writing or reading operations respectively every cycle of t70. In this case, the recording-reproduction time managing unit 301 manages the file system controller 30 so that the priorities of the file systems are altered every cycle of t70. The reason for this is that, since a task process such as media processing is carried out every constant cycle in most cases, it is expected that the efficiency of the media processing can be improved by giving priority to the second CPU 20 every constant cycle.

During the cycle t70, the second CPU 20 executes the respective data writing or reading operations 1021, 1022, 1023 and 1024, and when, during the cycle t70, a data writing or reading operation to the recording device 40 is required, the first CPU 10 executes data writing or reading operations 1011a, 1011b, 1012a on demand.

Moreover, after the writing or reading operation of the second CPU 20 has been stopped (executed upon detection of EOF (End of File) or the like), the first CPU 10 executes a data writing or reading operation 1012b independent of the above-mentioned cycle.

With the above-mentioned arrangement, the writing or reading operation of media data can be executed efficiently without being influenced by the writing or reading operation of general data. In other words, it becomes possible to always carry out a writing or reading operation of media data in real time.

### Embodiment 8

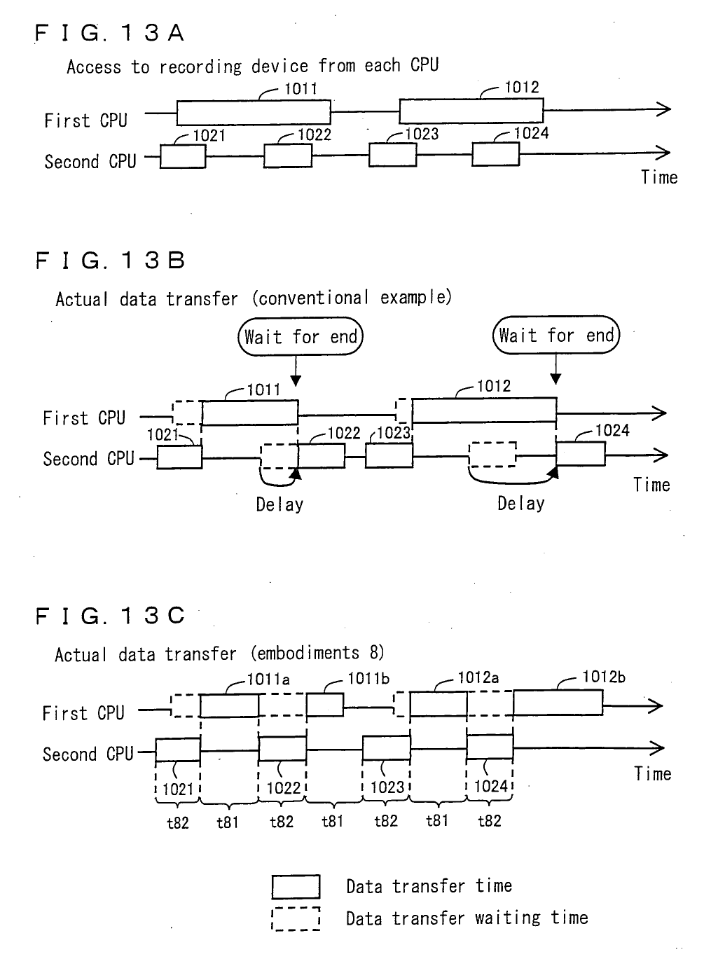

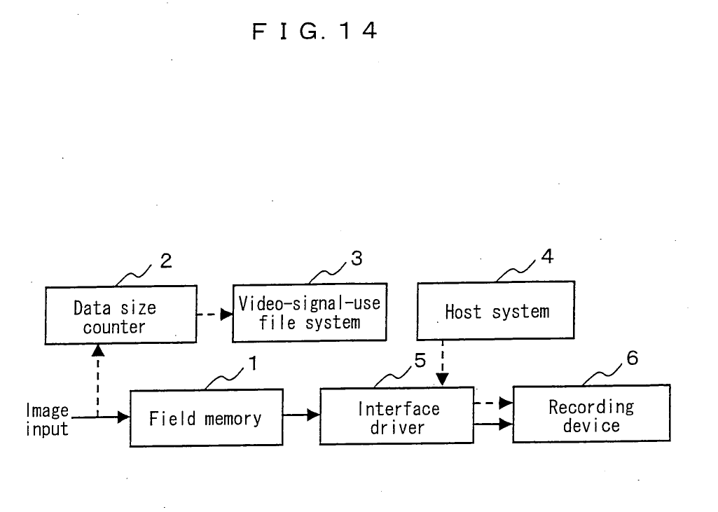

Referring to FIGS. 1 and 13, a file system control apparatus in accordance with the embodiment 8 of the present invention is explained.

In a file system control apparatus of the present embodiment, a first CPU 10 executes a writing or reading operation of general data such as document data on a single recording device 40 through the first file system 11, and the second CPU 20 executes a writing or reading operation of media data such as the AV data thereon through the second file system 21.

Moreover, in the case when the first CPU 10 and the second CPU 20 make accesses simultaneously, the writing or reading operation of the first CPU 10 and the writing or reading operation of the second CPU 20 are executed cyclically.

Here, with respect to the first CPU 10 and the second CPU 20, the respective cycles during which a writing or reading operation is executed are desirably set.

With this arrangement, the writing or reading cycle t82 of the second CPU 20 is made equal to the writing or reading cycle of a sampling rate of media data that are to be written or read so that it becomes possible to execute the data writing or reading operation more effectively.

For example, in FIG. 13, each of the first CPU 10 and the second CPU 20 executes a data writing or reading operation every cycle of t81 (t82).

During the cycle t82 that is the same writing or reading cycle of media data, the second CPU 20 executes the respective data writing or reading operations 1021, 1022, 1023 and 1024, and when, during the cycle t81, a data writing or reading operation to the recording device 40 is required, the first CPU 10 executes data writing or reading operations 1011a, 1011b, 1012a on demand.

Moreover, after the writing or reading operation of the second CPU 20 has been stopped, the first CPU 10 executes a data writing or reading operation 1012b independent of the above-mentioned cycle.

With the above-mentioned arrangement, the writing or reading operation of media data can be executed efficiently without being influenced by the writing or reading operation of general data. In other words, it becomes possible to always carry out a writing or reading operation of media data in real time.

### Embodiment 9

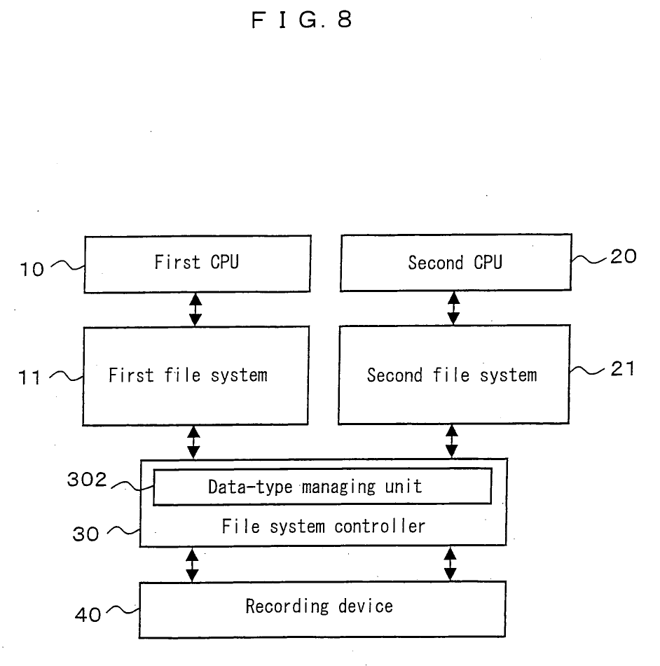

Referring to FIGS. 8 and 9, a file system control apparatus in accordance with the embodiment 9 of the present invention is explained.

In FIG. 8, reference numeral 302 represents a data-type managing unit that is installed in the system controller 30, and manages types of data to be written or read by the respective file systems. Since the other structures are the same as those of the embodiment 1 shown in FIG. 1, the same parts are indicated by the same reference numerals, and the description thereof is omitted.

In a file system control apparatus of the present embodiment, the first CPU 10 executes a writing or reading operation of general data such as document data on the single recording device 40 through the first file system 11, and the second CPU 20 executes a writing or reading operation of media data such the AV data thereon through the second file system 21.

The data-type managing unit 302, installed in the file system controller 30, manages types of data that are written or read by the first file system 11 and types of data that are written or read by the second file system 21. Based upon data-type information managed by the data-type managing unit 302, the file system controller 30 preferentially executes a writing or reading operation of media data.

For example, in the case when, while the first CPU 10 is executing a writing or reading operation of general data on the recording device 40, the second CPU 20 starts to execute a writing or reading operation of media data on the recording device 40, the file system controller 30 automatically stops the writing or reading operation of the first CPU 10, and preferentially executes a writing or reading operation of the second CPU 20.

For example, in FIG. 9, the data writing or reading operation 1011 of the first CPU 10 is stopped, and the writing or reading operation 1023 of the second CPU 20 is preferentially carried out. As a result, the second CPU 20, which executes a writing or reading operation of media data, is always allowed to carry out a writing or reading operation of media data on demand in real time.

With the above-mentioned arrangement, the writing or reading operation of media data can be executed efficiently without being influenced by the writing or reading operation of general data. In other words, it becomes possible to always carry out a writing or reading operation of media data in real time.

Additionally, the above-mentioned embodiments have exemplified a case in which the file system is executed on CPUs; however, the present invention is not intended to be limited by this case. For example, the present invention is applicable to a case in which the execution of a file system is controlled on an application. Moreover, in this case, it is not necessary to prepare a CPU for each of file systems, and a plurality of applications may of course be executed on a single CPU.

While the invention has been described and illustrated in detail, it is to be clearly understood that this is intended by way of illustration and example only and is not to be taken by way of limitation, the spirit and scope of this invention being limited only by the terms of the following claims.

1. A file system control apparatus comprising:
a first control unit that controls processing of first data;
a first file system that is subjected to the processing by the first control unit;
a second control unit that controls processing of second data;
a second file system that is subjected to the processing by the second control unit; and
a file system controller that controls the two file systems,
wherein, even when, upon execution of an access to the recording device by the first file system, an access execution request for the recording device is given by the second file system, the file system controller carries out a control operation so as not to delay the access execution of the second file system due to the access execution of the first file system.

2. The file system control apparatus according to claim 1,
wherein when, upon execution of the access to the recording device by the first file system, the access execution request for the recording device is given by the second file system, the file system controller suspends the access execution of the first file system to the recording device so that the access execution of the second file system is preferentially carried out.

3. The file system control apparatus according to claim 2,
wherein upon completion of the access execution of the second file system to the recording device, the file system controller resumes the access execution of the first file system to the recording device again.

4. The file system control apparatus according to claim 1,
wherein the first and second file systems have respective priorities for access execution, and the second file system has a higher priority for access execution than the first file system.

5. The file system control apparatus according to claim 1,
wherein the first control unit is a CPU that mainly controls a writing or reading operation of general data, and the second control unit is the CPU that mainly controls a writing or reading operation of media data.

6. The file system control apparatus according to claim 1,
wherein the two file systems are controlled so as to be respectively executed on the corresponding applications.

7. The file system control apparatus according to claim
wherein the second file system has a cache buffer,
and while the first file system is not executing an access to the recording device, the file system controller carries out controlling processes, with the data corresponding to the second file system of the recording device being preliminarily transferred to the cache buffer, so that the access execution of the second file system to the cache buffer and the access execution of the first file system to the recording device are carried out simultaneously.

8. The file system control apparatus according to claim 7,
wherein the second file system further comprises a buffer-size managing unit,
and upon notification of the fact that the cache buffer has been completely filled from the buffer-size managing unit, the file system controller allows the first file system to execute an access to the recording device, while upon notification of the fact that the cache buffer has become empty from the buffer-size managing unit, the file system controller controls in such a manner that the corresponding data of the recording device is preliminarily transferred to the cache buffer, when the first file system is not executing the access to the recording device.

9. The file system control apparatus according to claim 1,
wherein the second file system has a secure mechanism,
and the file system controller carries out controlling operations so that the access execution of the second file system to the recording device is preferentially carried out depending on the presence or absence of the secure mechanism.

10. The file system control apparatus according to claim 1,
wherein the first file system has a journaling mechanism,
and the file system controller carries out controlling operations so that the access execution of the second file system to the recording device is preferentially carried out depending on the presence or absence of the journaling mechanism.

11. The file system control apparatus according to claim 1,
wherein the file system controller comprises a recording-reproduction time managing unit that outputs a constant cycle,
controls operations so that an access execution of the second file system to the recording device is carried out every constant cycle.

12. The file system control apparatus according to claim 11,
wherein time during which an access execution of the first file system to the recording device is carried out is made different from time during which an access execution of the second file system to the recording device is carried out.

13. The file system control apparatus according to claim 1,
wherein the file system controller has a data-type managing unit that reads data-type information possessed by the two file systems,
and in accordance with the data-type information, the second file system is allowed to preferentially execute an access to the recording device.

14. The file system control apparatus according to claim 13,
wherein the second file system has a data type of media processing and the first file system has a data type of general data processing other than the media processing.

15. A file system control method for controlling
a first file system that is subjected to the processing by a first control unit that controls processing of first data and a second file system that is subjected to the processing by a second control unit that controls processing of second data comprising the steps of: judging whether an access execution request for the recording device is given by the second file system upon execution of an access to the recording device by the first file system; and
controlling operation so as not to delay the access execution of the second file system due to the access execution of the first file system when the access execution request is given by the second file system.

16. The file system control method according to claim 15,
wherein in controlling, the access execution of the first file system to the recording device is suspended so that the access execution of the second file system is preferentially carried out.

17. The file system control method according to claim 16,
wherein in controlling, upon completion of the access execution of the second file system to the recording device, the access execution of the first file system to the recording device is resumed again.

18. The file system control method according to claim 15,
wherein the first and second file systems have respective priorities for access execution, and the second file system has a higher priority for access execution than the first file system.

19. The file system control method according to claim 15,
wherein the first control unit is a CPU that mainly controls a writing or reading operation of general data, and the second control unit is the CPU that mainly controls a writing or reading operation of media data.

20. The file system control method according to claim 15,
wherein the two file systems are controlled so as to be respectively executed on the corresponding applications.

21. The file system control method according to claim 15,
wherein the second file system has a cache buffer,
and in controlling, while the first file system is not executing an access to the recording device, with the data corresponding to the second file system of the recording device being preliminarily transferred to the cache buffer, so that the access execution of the second file system to the cache buffer and the access execution of the first file system to the recording device are carried out simultaneously.

22. The file system control method according to claim 21,
wherein the second file system further comprises a buffer-size managing unit,
and in controlling, upon notification of the fact that the cache buffer has been completely filled from the buffer-size managing unit, the first file system is allowed to execute an access to the recording device, while upon notification of the fact that the cache buffer has become empty from the buffer-size managing unit, the corresponding data of the recording device is preliminarily transferred to the cache buffer, when the first file system is not executing the access to the recording device.

23. The file system control method according to claim 15,
wherein the second file system has a secure mechanism,
and in controlling, the access execution of the second file system to the recording device is preferentially carried out depending on the presence or absence of the secure mechanism.

24. The file system control method according to claim 15,
wherein the first file system has a journaling mechanism,
and in controlling, the access execution of the second file system to the recording device is preferentially carried out depending on the presence or absence of the journaling mechanism.

25. The file system control method according to claim 15,
wherein in controlling, an access execution of the second file system to the recording device is carried out every constant cycle.

26. The file system control method according to claim 25,
wherein time during which an access execution of the first file system to the recording device is carried out is made different from time during which an access execution of the second file system to the recording device is carried out.

27. The file system control method according to claim 15,
wherein in controlling, in accordance with a data-type information possessed by the two file systems, the second file system is allowed to preferentially execute an access to the recording device.

28. The file system control method according to claim 27,
wherein the second file system has a data type of media processing and the first file system has a data type of general data processing other than the media processing.
